(19) United States
(12) Patent Application Publication
(10) Pub. No.: US 2026/0292313 A1
(43) Pub. Date: Sep. 24, 2026

(54) CUSTOMIZED SUMMARIZATION CONTENT BASED ON CONTENT CONSUMPTION STATUS AND USER STATUS

(71) Applicant: Samsung Electronics Co., Ltd., Suwon-si (KR)

(72) Inventors: Wenpin Li, South Orange, NJ (US); Yuanyuan Song, Hoboken, NJ (US); Ha Jin Choi, Springfield, NJ (US); Myoung Woo Nam, Yongin-si (KR); Yeun Wook Lim, Daegu (KR)

(21) Appl. No.: 19/087,063

(22) Filed: Mar. 21, 2025

(51) Int. Cl. H04N 21/84; H04N 21/442

(52) U.S. Cl. CPC H04N 21/84; H04N 21/44222

(57) ABSTRACT

To provide customized content summarization based on a content consumption status and a user status, during consumption of content by a user, user content consumption attributes including one or more of stage changes, device status, content key points, and user interactions with the content are identified for an aggregate consumed portion of the content. When the user pauses the consumption of the content for a time period exceeding a threshold, generative artificial intelligence prompts for summarization of the aggregate consumed portion of the content are determined based on the user content consumption attributes, Upon user return to the consumption of the content, whether to present the summarization to the user is determined, as well as format, length and level of detail of the summarization.

### TECHNICAL FIELD

This disclosure relates generally to user content consumption. More specifically, this disclosure relates to improving the user experience during interrupted content consumption.

### BACKGROUND

In today's fast-paced world today, users consume vast amounts of content. With busy lifestyles, recalling or comprehending previously consumed content is challenging for users. Especially when the user is switching environments and/or being interrupted with different time intervals, information retention is particularly challenging. It is common for users to pause and return to the content later, after weeks or months. Studies suggest that, based on one hour of content, users retain only about 25% of information by day seven, and recall about 2%-3% of the original hour by day 30. Further, users may struggle with loss of context when resuming content with a disconnected experience, requiring the user to spend additional time exploring, re-reading, or re-watching previously experienced content in order to regain contextual awareness. This inefficiency may lead to boredom or frustration on the part of the user.

### SUMMARY

This disclosure relates to providing personalized summarization content based on content consumption status and user status.

In a first embodiment, a method of providing customized content summarization based on a content consumption status and a user status includes identifying, for an aggregate consumed portion of the content during consumption of the content by a user, user content consumption attributes including one or more of stage changes, device status, content key points, and user interactions with the content. The method also includes determining generative artificial intelligence prompts for summarization of the consumed portion of the content based on the user content consumption attributes, when the user pauses the consumption of the content for a time period exceeding a threshold. The method further includes determining whether to present the summarization to the user, upon user return to the consumption of the content.

Any single one or any combination of the following features may be used with the first embodiment. Determining the generative artificial intelligence prompts for summarization of the aggregate consumed portion of the content may include determining a type, a style, and a length of the summarization or device settings for presentation of the summarization. Determining the type, the style, and the length of the summarization may include determining a format of the summarization based on user content consumption behavior. The user content consumption attributes may include one or more of: user preferences, or user content consumption behavior. Determining the generative artificial intelligence prompts for summarization of the aggregate consumed portion of the content may include determining the generative artificial intelligence prompts based at least in part on one or more of: a proportion of the aggregate consumed portion of the content to a total amount of the content, a duration of the time period during which the user pauses the consumption of the content, or a resumption point when the user returns to the content. Determining whether to present the summarization to the user is based at least in part on one of: the proportion of the aggregate consumed portion of the content to the total amount of the content, or the duration of the time period during which the user pauses the consumption of the content. Determining whether to present the summarization to the user may include requesting user confirmation for presentation of the summarization.

In a second embodiment, an electronic device for providing a customized content summarization based on a content consumption status and a user status includes at least one processing device. The processing device is configured to identify, for an aggregate consumed portion of the content during consumption of the content by a user, user content consumption attributes including one or more of stage changes, device status, content key points, and user interactions with the content. The processing device is also configured to determine generative artificial intelligence prompts for summarization of the consumed portion of the content based on the user content consumption attributes when the user pauses the consumption of the content for a time period exceeding a threshold. The processing device is further configured to determine whether to present the summarization to the user upon user return to the consumption of the content.

Any single one or any combination of the following features may be used with the second embodiment. Determining the generative artificial intelligence prompts for summarization of the aggregate consumed portion of the content may include determining a type, a style, and a length of the summarization or device settings for presentation of the summarization. Determining the type, the style, and the length of the summarization may include determining a format of the summarization based on user content consumption behavior. The user content consumption attributes may include one or more of: user preferences, or user content consumption behavior. Determining the generative artificial intelligence prompts for summarization of the aggregate consumed portion of the content may include determining the generative artificial intelligence prompts based at least in part on one or more of: a proportion of the aggregate consumed portion of the content to a total amount of the content, a duration of the time period during which the user pauses the consumption of the content, or a resumption point when the user returns to the content. Determining whether to present the summarization to the user is based at least in part on one of: the proportion of the aggregate consumed portion of the content to the total amount of the content, or the duration of the time period during which the user pauses the consumption of the content. Determining whether to present the summarization to the user may include requesting user confirmation for presentation of the summarization.

In a third embodiment, a non-transitory machine readable medium for providing a customized content summarization based on a content consumption status and a user status includes instructions that when executed cause at least one processing device of an electronic device to identify, for an aggregate consumed portion of the content during consumption of the content by a user, user content consumption attributes including one or more of stage changes, device status, content key points, and user interactions with the content. The instructions when executed also cause the processing device to determine generative artificial intelligence prompts for summarization of the consumed portion of the content based on the user content consumption attributes when the user pauses the consumption of the content for a time period exceeding a threshold. The instructions when executed further cause the processing device to determine whether to present the summarization to the user upon user return to the consumption of the content.

Any single one or any combination of the following features may be used with the third embodiment. Determining the generative artificial intelligence prompts for summarization of the aggregate consumed portion of the content may include determining a type, a style, and a length of the summarization or device settings for presentation of the summarization. Determining the type, the style, and the length of the summarization may include determining a format of the summarization based on user content consumption behavior. The user content consumption attributes may include one or more of: user preferences, or user content consumption behavior. Determining the generative artificial intelligence prompts for summarization of the aggregate consumed portion of the content may include determining the generative artificial intelligence prompts based at least in part on one or more of: a proportion of the aggregate consumed portion of the content to a total amount of the content, a duration of the time period during which the user pauses the consumption of the content, or a resumption point when the user returns to the content. Determining whether to present the summarization to the user is based at least in part on one of: the proportion of the aggregate consumed portion of the content to the total amount of the content, or the duration of the time period during which the user pauses the consumption of the content. Determining whether to present the summarization to the user may include requesting user confirmation for presentation of the summarization.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. In addition, implementations may involve cloud-based content or wirelessly communicated content, such that the non-transitory computer readable medium is not limited to an electronic device's local memory.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD) or other Bluetooth-enabled headsets, electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IOT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for providing personalized summarization content based on content consumption and user status in accordance with this disclosure;

FIG. 2 illustrates an example process of providing personalized summarization content based on content consumption and user status in accordance with this disclosure;

FIG. 3 is a diagram illustrating a system for providing personalized summarization content based on content consumption and user status in accordance with this disclosure;

FIG. 4 illustrates an example process of providing personalized summarization content based on content consumption and user status in accordance with this disclosure;

FIG. 5 illustrates an example prioritization scheme of key information identified while providing personalized summarization content based on content consumption and user status for in accordance with this disclosure;

FIG. 6 illustrates a process for determining a summarization format while providing personalized summarization content based on content consumption and user status for in accordance with this disclosure;

FIGS. 7A, 7B, and 8 illustrate a specific example of providing personalized summarization content based on content consumption and user status in accordance with FIGS. 3 and 4 of this disclosure;

FIG. 9 illustrates a plot for content summarization size based on initial content consumption and pause duration when providing personalized summarization content based on content consumption and user status in accordance with this disclosure;

FIG. 10 illustrates a bar graph for user content consumption behavior as a basis for content summarization detail when providing personalized summarization content based on content consumption and user status in accordance with this disclosure; and

FIGS. 11A through 11C illustrate plots for measured user content consumption behavior, and FIG. 11D illustrates a plot of aggregated behaviors, as a basis for content summarization detail when providing personalized summarization content based on content consumption and user status in accordance with this disclosure.

### DETAILED DESCRIPTION

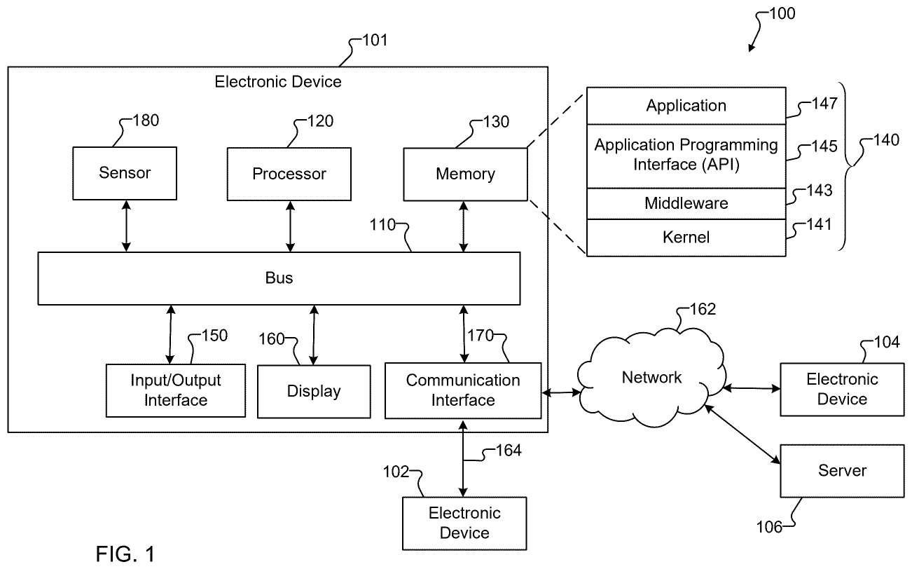

FIGS. 1 through 11D, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, users may struggle with loss of context when resuming content with a disconnected experience, requiring the user to spend additional time exploring, re-reading, re-listening, or re-watching previously experienced content in order to regain contextual awareness, which then may lead to boredom or frustration on the part of the user.

For example, when a user reads an e-book sporadically, every time the user resumes reading the user may not recall the context from previously read chapters. The user may need to flip between pages or skim through lengthy text to help regain awareness of the characters, plot, etc. This process generates boredom or indifference due to repetitive actions and inefficiencies, and also cannot provide an intuitive content which refreshes user's memory rapidly and vividly.

To help users seamlessly resume the content consumption without losing previous context, the present disclosure discloses a system that analyzes user's content consumption behaviors and leverages the power of generative artificial intelligence (Gen-AI) to provide a generative summarization of previous consumed content, tailored to the user's content consuming patterns and status and helping user retain/recall and comprehend information more effectively.

The present disclosure exploits multiple technology fields, including:
Gen-AI summarization: Technology of using AI models to generate a summarized output in the form of visual representations or audio narratives that capture the essence of the content.
Automatic digitalization: Process of converting various formats of content into another format using device's built-in capabilities.
Machine learning and Gen-AI data training: Process of using algorithms to model and predict a user's media preferences, and enabling generation of personalized summarization content.

To define Gen-AI prompts at different stages of content consumption, when a user is consuming a type of content, pauses, and stays away for a long time, and the user returns to the content at the point where the user left off (e.g., by opening the app, returning to the browser window, etc.). Stage changes are detected when the content is being consumed and, throughout the stages, information on the user's consumption behavior is identified, together with previously consumed content, user's general data such as settings preferences, etc. Key information is extracted into a group of prompts for Gen-AI to utilize as instructions, to generate a form of summarization.

To determine the necessity of summarization, based on user progress and time away from content, a threshold is used to decide when summarization needs to be provided and the length and level of detail that needs to be included in the summarization.

To further define the summarization's level of detail, based on the user's consumption behavior throughout a consuming process, the user's various interactions with the content are captured. Each time the user returns to the content at a certain progress point, the interactions logged in previous consumption will determine the level of detail to be included in the summarization.

FIG. 1 illustrates an example network configuration 100 that may be employed for providing personalized summarization content based on content consumption and user status in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to providing personalized summarization content based on content consumption status and user status.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS). The present disclosure is agnostic as to whether the memory 130 includes local storage, cloud-base sources, or both and as to whether and application package kit providing functionality described herein calls a system partition or a cloud-based source.

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to providing personalized summarization content based on content consumption status and user status. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a virtual, augmented display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 (e.g., a smart watch or a smart phone) through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to providing personalized summarization content based on content consumption and user status. For example, the electronic device 101 may be employed to consume content, while the server 106 may be employed to generate a summarization of previously consumed content portions for presentation when a user resumes previously paused content consumption on the electronic device 101.

Although FIG. 1 illustrates one example of a network configuration 100 including an electronic device 101 employed providing personalized summarization content based on content consumption and user status, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

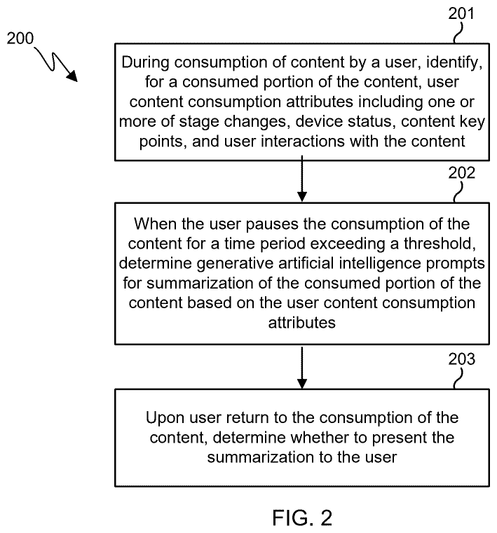

FIG. 2 illustrates an example process 200 of providing personalized summarization content based on content consumption and user status in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

As shown in FIG. 2, the process 200 begins with identifying, for a consumed portion of the content during consumption of the content by a user, user content consumption attributes including one or more of stage changes (e.g., the user is consuming=>changed to user pauses consumption=>changed to user resumes consumption=>changed to user again pauses, etc.), device status, content key points, and user interactions with the content (operation 201). The phrase “a consumed portion of the content” encompasses the accumulation of multiple portions consumed at different times, each with an intervening pause in consumption. Device status may include screen brightness, volume level, connection to WiFi, and Bluetooth connection to an output device. Stage changes may include change of scene, character development, and plot points. User content consumption attributes may include specific user interactions with the content (e.g., rewinding or repeating, fast forwarding, screenshotting, or online keyword searches) and/or general user data (e.g., preferences regarding audio or visual appearance, display of subtitles, etc.).

When the user pauses the consumption of the content for a time period exceeding a threshold, generative artificial intelligence prompts for summarization of the consumed portion of the content are determined based on the user content consumption attributes (operation 202). This may include determining a type, a style, and a length of the summarization and/or a format of the summarization. The generative artificial intelligence prompts based at least in part on one or more of: a proportion of the consumed portion of the content to a total amount of the subject content, or a duration of the time period during which the user pauses the consumption of the subject content, or optionally also the user's metadata (preferred settings and the like) in connection with consumption of other content in the time period during which the user pauses the consumption of the subject content.

Upon user return to the consumption of the content, whether to present the summarization to the user is determined (operation 203). This may be determined based at least in part on one or more of: a proportion of the consumed portion of the content to a total amount of the content, or a duration of the time period during which the user pauses the consumption of the content. User confirmation for presentation of the summarization may be requested.

Although FIG. 2 illustrates one example of a process 200 of providing personalized summarization content based on content consumption and user status, various changes may be made to FIG. 2. For example, while shown as a series of steps, various steps in FIG. 2 could overlap, occur in parallel, occur in a different order, or occur any number of times (including zero times).

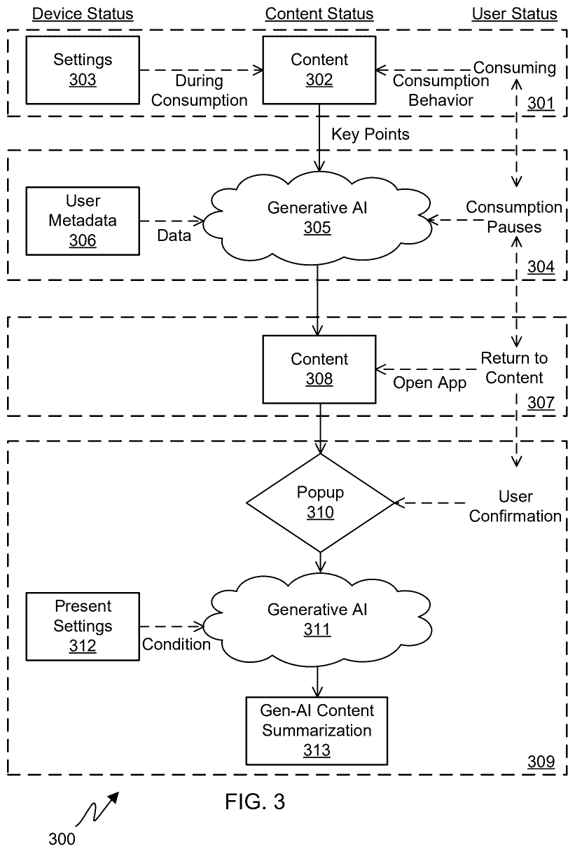

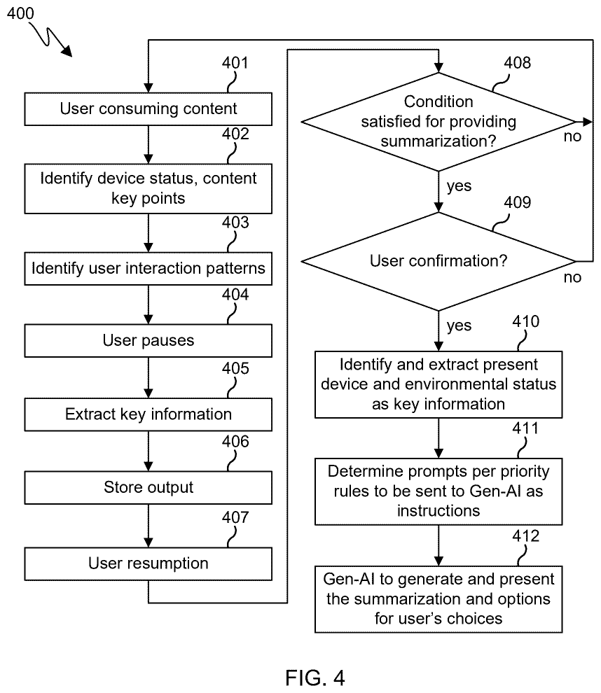

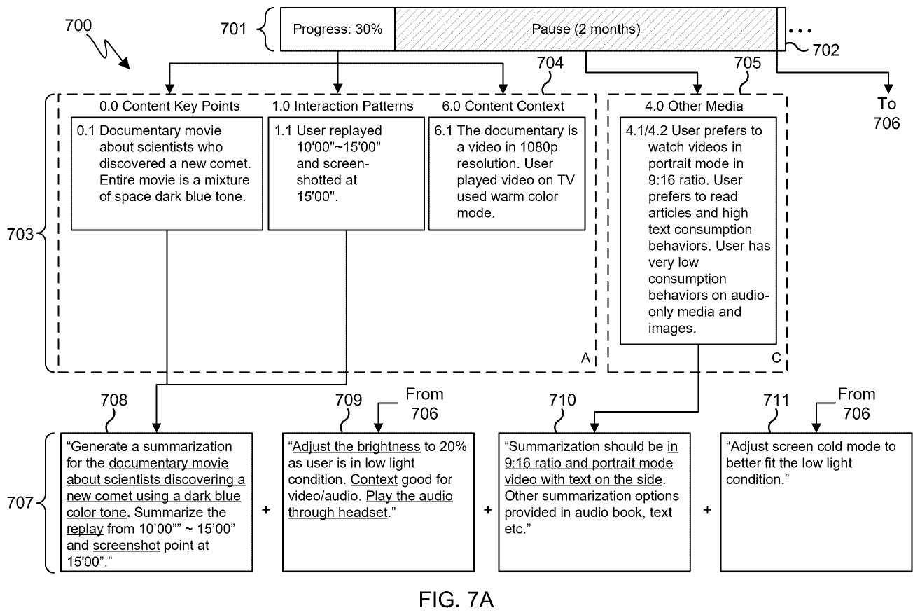

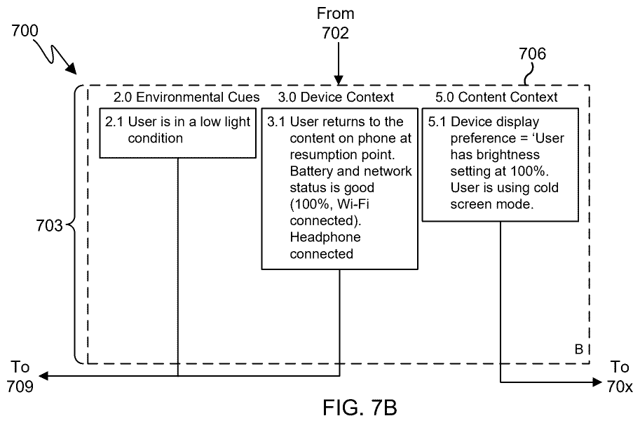

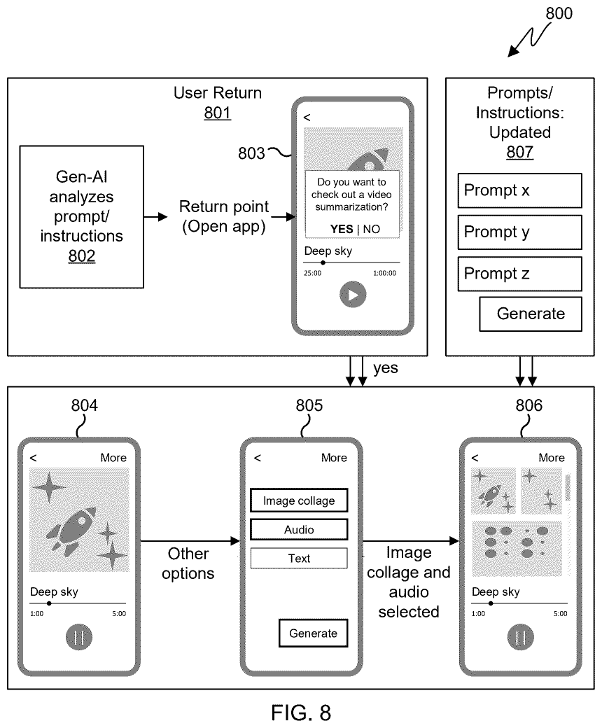

FIG. 3 is a diagram illustrating a system 300 for providing personalized summarization content based on content consumption and user status in accordance with this disclosure. For ease of explanation, the system 300 of FIG. 3 is described as being implemented within the electronic device 101 and the server 106 in the network configuration 100 of FIG. 1, operating interactively. However, the system 300 may be implemented using any other suitable device(s) and in any other suitable system(s). Operation of the system 300 is described in further detail below in connection with FIG. 4, and a specific example is described in connection with FIGS. 7A, 7B, and 8.

In the system 300 of FIG. 3, various aspects of device status, content status, and user status are taken into account. During the time of initial user consumption 301, the user is consuming content for a period of time during which a certain portion of the content becomes consumed content 302. When a user is consuming a type of content, the user may pause consumption and stay away for a significant amount of time. This may occur iteratively, with the user consuming multiple content portions with intervening pauses such that the accumulation of multiple content portions becomes the consumed content 302.

During this initial user consumption 301, the system 300 detects stage changes within the consumed content 302 and, throughout the stages of user consumption, identifies device settings 303 and determines information relating to the user's consumption behavior (which becomes user metadata described below) and the like. Key information-key points for the consumed content 302, device settings 303, and user consumption behavior-is extracted for use in deriving prompts for Gen-AI to utilize as instruction to generate a form of summarization. While the user is consuming any type of content, the system 300 detects when the content is being consumed on the device and identifies key information of: key points relating to the consumed content 302, such as the genre or theme of a movie; present device settings 303 (discussed in further detail below); and the user's interaction patterns with the content during consumption.

When the consumption pauses 304 for a relatively long time, the key information that has been extracted is formed into prompts using a priority rule (also discussed in further detail below), to define instructions for Gen-AI 305 to utilize in generating an output (summarization) of the previously consumed content 302. The user consumption behavior (or, as termed below, user interactions with the content during consumption) becomes the basis for user metadata 306 employed by Gen-AI 305.

When (or each time) the user returns 307 to consuming the content (e.g., by opening the app, returning to a browser window, etc.), the user is returned to the remaining content 308 (the non-consumed portion of the total content) at the point where consumption left off. Upon user return 307 for continued consumption, the presentation 309 of the remaining content 308 and user consumption thereof nominally resumes at the point at which consumption was paused.

User return 307 to resume consumption will, when a condition (described in further detail below) is satisfied, trigger a popup 310 as part of presentation 309, seeking user confirmation (consent) to be presented a form of summarization at the return point, prior to resuming consumption of the remaining content 308. Upon receiving user consent, and based in part of the present settings 312 for the device, Gen-AI 311 presents the generated content summarization 313, which may be in one of a range of formats including but not limited to text, video, image collage, audio, etc.

Although FIG. 3 illustrates one example of a system 300 for providing personalized summarization content based on content consumption and user status, various changes may be made to FIG. 3. For example, while depicted separately, Gen-AI 305 and Gen-AI 311 may be the same model, invoked on different occasions, or may be different models. As apparent, content 302 and content 308 are the same content, at different points of user consumption. Settings 303 and present settings 312 may or may not relate to the same device, since the user may initiate user consumption on a first device but resume consuming the content on a second device.

FIG. 4 illustrates an example process 400 of providing personalized summarization content based on content consumption and user status in accordance with this disclosure. For ease of explanation, the process 400 of FIG. 4 is described as being performed using the electronic device 101 in the network configuration 100 of FIG. 1. However, the process 400 may be performed using any other suitable device(s) and in any other suitable system(s).

When content is being consumed on a device, the system 300 detects consumption and identifies key information of: device status, content key points such as the genre or theme; and the user's interaction patterns in the content. When the user pauses for an interval of time away from the content, the key information is extracted from the metadata that defines user's other media consumption preferences on the device. This key information is stored in the system 300 and, upon the user's resumption if a condition is satisfied, the user will be prompted to consent to be presented a form of summarization at the return point, which will be based on the key information from the device and environmental status (including user's metadata) at the time of resumption. The key information is extracted as Gen-AI prompts to generate the summarization.

As shown in FIG. 4, the process 400 begins with the user consuming content (operation 401). Examples of consuming video content are used herein, but the content could alternatively be (for example) an e-book, audio content, a blog, or multi-part social media posts. Even for video content, the content may take any of a variety of forms such as a movie, an episodic series, or the like. Upon initiation of—and preferably during—user consumption of the content, device status and content key points are identified (operation 402). Device status may include settings such as screen brightness, audio output, etc. Content key points may relate to characters, plot, location, genre, etc. Patterns of user interaction with the content are also identified (operation 403). Short pausing of the content, fast forwarding through segments or rewinding to replay segments, or searches on keywords (e.g., people names, places, concepts), are among the types of user interaction that is of interest.

When the user pauses consumption of the content (operation 404) for at least a threshold time period, key information relating to the consumed portion of the content is extracted (operation 405). Examples of such key information for device status, content key points, user interaction with the content, and general user data are described below. The extracted key information is stored (operation 406), and upon user resumption (operation 407), satisfaction of a condition for providing summarization of the previously consumed portion of the content is checked (operation 408). The condition may involve one or any combination of the duration of time since the user paused consumption, the proportion of the consumed part of the content to the total content, user consumption of other content in the interim since consumption of the subject content was paused, etc. A specific example of a suitable condition is described below in connection with FIGS. 7A and 7B. User confirmation for presentation of a summarization of the previously consumed portion of the content is sought (operation 409). If both the condition is satisfied and user confirmation is obtained, the stored key information and present device and environmental status are identified (operation 410) and analyzed to determine prompts for Gen-AI summarization of the consumed portion of the content (operation 411). In addition, the type, style, visual(s), length, and other details of the output used in connection with the consumed portion of the content are determined, and the prompts and determined output characteristics are employed to present the summarization (operation 412), with options for user choices as to format, etc.

Although FIG. 4 illustrates one example of a process 400 of providing personalized summarization content based on content consumption and user status, various changes may be made to FIG. 4. For example, while shown as a series of steps, various steps in FIG. 4 could overlap, occur in parallel, occur in a different order, or occur any number of times (including zero times).

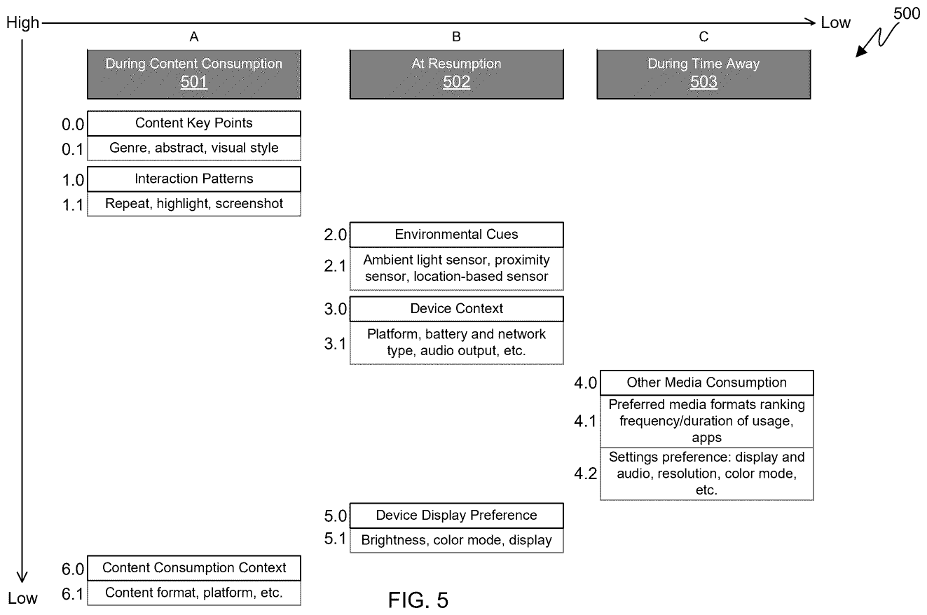

FIG. 5 illustrates an example prioritization scheme 500 of key information identified while providing personalized summarization content based on content consumption and user status for in accordance with this disclosure. For ease of explanation, the prioritization scheme 500 of FIG. 5 is described as being used while operating the electronic device 101 in the network configuration 100 of FIG. 1. However, the prioritization scheme 500 may be performed using any other suitable device(s) and in any other suitable system(s).

The prioritization scheme 500 of FIG. 5 establishes priority rules for extracted key information. The prioritization scheme 500 categorizes key information based on when extracted: during content consumption 501 (category “A”); at resumption 502 (category “B”) after the user pauses content consumption; and during time away 503 (category “C”) before the user resumes consumption.

The key information is collected and organized into prompts for Gen-AI following a set of priority rules that will guide the AI on how to process the information based on the defined hierarchy: timing categories (A>B>C) and type categories (0>1>2>3 . . . ), where the type category integers identify a specific type of information and type category decimals identify specific examples. Under this defined hierarchy, prioritization ranges from high to low as follows:
Highest priority: Takes precedence and must be accounted for in the summarization output (includes key information about the content itself, not limited to: genre, abstract, visual style, etc.; user's interaction patterns not limited to replay, highlight, screenshot etc.; format of original content, platform, etc.).
Medium priority: Information included if complementary to or an enhancement of high priority key information (includes key information about the device's present context, not limited to: environmental status such as ambient light sensor status, etc.; platform used, battery status, network, etc.; display preference such as current settings).
Lowest priority: Information included only if no conflict with higher priorities exists, and if the information adds meaning context (includes key information about the other media consumption preferences, not limited to: format preference such as highest video, then audio book, then image, then text, etc.; settings preferences used while consuming these media types, etc.).

The system 300 will process the key information in the following order:
a. Extract information from all stages of user consumption and tag with respective priorities.
b. Filter lower priority and validate, reconcile conflicts.
c. Synthesize the information into coherent structure, ensuring the above priority rules are followed.

The exemplary key information in the example of FIG. 5 includes:

| Type Category | |
|---|---|
| Identifier | Description |
| 0.0 | Content Key Points, etc. |
| 0.1 | Genre, abstract, visual style, etc. |
| 1.0 | Interaction Patterns, etc. |
| 1.1 | Repeat, highlight, screenshot, etc. |
| 2.0 | Environmental Cues, etc. |
| 2.1 | Ambient light sensor, proximity sensor, |
| | location-based sensor, etc. |
| 3.0 | Device Context, etc. |
| 3.1 | Platform, battery and network type, |
| | audio output, etc. |
| 4.0 | Other Media Consumption, etc. |
| 4.1 | Preferred media formats ranking |
| | frequency/duration of usage, apps, etc. |
| 4.2 | Settings preference: display and audio, |
| | resolution, color mode, etc. |
| 5.0 | Device Display Preference, etc. |
| 5.1 | Brightness, color mode, display, etc. |
| 6.0 | Content Consumption Context, etc. |
| 6.1 | Content format, platform, etc. |

Whether used by Gen-AI in prioritizing between the video/audio-based summarization versus a text/image-based summarization depends on segments within priority B: key information extracted at resumption 502. If condition satisfied for a better performance format, it should then prioritize user's preference of video/audio for other media consumption. Otherwise, Gen-AI should prioritize image/text-based summary considering present user's status.

Although FIG. 5 illustrates one example of a prioritization scheme 500 for key information, various changes may be made to FIG. 5. For example, prioritizations in FIG. 5 could overlap either in the timing categories or the type categories.

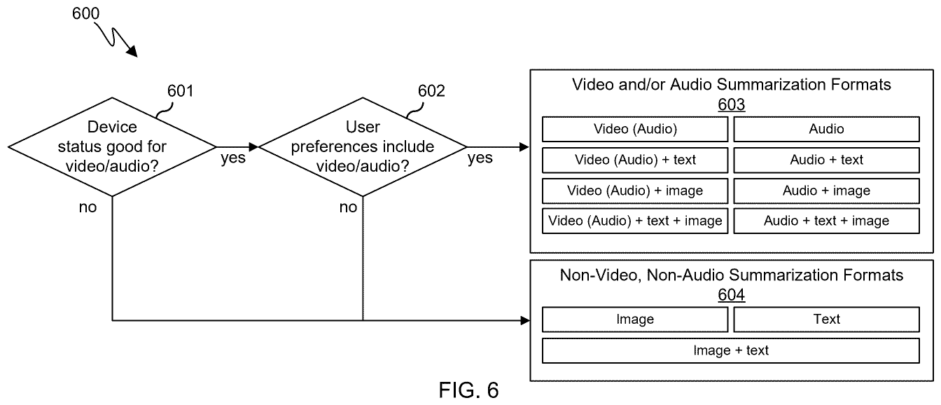

FIG. 6 illustrates a process 600 for determining a summarization format while providing personalized summarization content based on content consumption and user status for in accordance with this disclosure. For ease of explanation, the process 600 of FIG. 6 is described as being performed using the electronic device 101 in the network configuration 100 of FIG. 1. However, the process 600 may be performed using any other suitable device(s) and in any other suitable system(s).

The process 600 of FIG. 6 begins with a determination of whether the device status is good for video/audio (operation 601). If so, a determination is made of whether the user preferences include video/audio (operation 602). If so, the Gen-AI summarizations are generated in a variety of formats 603 including video, audio, or both (as well as, optionally, either text and/or images). If either the device status is not suitable for video/audio or the user preferences do not include video/audio, the Gen-AI summarizations are generated one or more non-video, non-audio formats 604 including images and/or text.

Although FIG. 6 illustrates one example of a process 600 for determining a summarization format, various changes may be made to FIG. 6. For example, while shown as a series of steps, various steps in FIG. 6 could overlap, occur in parallel, occur in a different order, or occur any number of times (including zero times).

FIGS. 7A, 7B, and 8 illustrate specific examples of a workflow 700 and a user interaction framework 800 for providing personalized summarization content based on content consumption and user status in accordance with FIGS. 3 through 5 of this disclosure, for a user experience watching the documentary video “Deep Sky” (2023). FIGS. 7A and 7B illustrate data identified during provision of personalized summarization content based on content consumption and user status. User consumption of the video content 701 is illustrated as a progress bar. The user consumes 30% of the video content 701, then pauses for 2 months before resumption 702. Key information 703 is extracted in stages, according to the prioritization scheme 500 in FIG. 5 (i.e., timing categories “A,” “B,” and “C”).

The key information 703 regarding device status, content status, and user interaction patterns that is identified is also depicted in FIGS. 7A and 7B. In the example of FIGS. 7A and 7B, the user watches the documentary for about the first 30%, for which the device status, the content's key points, and the user's interaction patters will be identified. The system collects details such as brightness, movie genre, and fast forward interactions. In this example, the user pauses at 30% and leaves the content, after which the user's general data (such as settings preferences and the like) will be identified to obtain the user's display, audio and content consuming preferences.

During the user's consumption of the video content 701, timing category “A” key information 704 that is extracted includes:
0.0 Content Key Points
0.1 Documentary movie about scientists discovered a new comet. Entire movie is a mixture of space dark blue tone.
1.0 Interaction Patterns
1.1 User replayed 10′00″~15′00″ and screenshotted at 15′00″.
6.0 Content context
6.1 The documentary is a video in 1080p resolution. User played video on TV used warm color mode.

While the user's consumption of the video content 701 is paused, timing category “C” key information 705 that is extracted includes:
4.0 Other Media
4.1 User prefers to watch videos in portrait mode in 9:16 ratio. User prefers to read articles and high text consumption behaviors.
4.2 User has very low consumption behaviors on audio-only media and images.

Upon the user's resumption 702 of consuming the video content 701, timing category “B” key information 706 that is extracted includes:
2.0 Environmental cues
2.1 User is in a low light condition.
3.0 Device context
3.1 User returns to the content on phone at resumption point. Battery and network status is good (100%, Wi-Fi connected). Headphone connected.
5.0 Content context
5.1 Device display preference=‘User has brightness setting at 100%. User is using cold screen mode.

The extracted key information 703 is organized according to the priority rules described in connection with FIG. 5 and used to create Gen-AI prompts 707. Timing category “A” information 704—specifically, type category “0.0 Content Key Points” and type category “1.0 Interaction Patterns”—is used to create the primary Gen-AI prompt 708: “Generate a summarization for the documentary movie about scientists discovering a new comet using a dark blue color tone. Summarize the replay from 10′00“ ” ~ 15′00″ and screenshot point at 15′00″.” Notably, type category “6.0 Content Context” key information within timing category “A” key information 704 is not employed to create any Gen-AI prompt in the example shown, under the prioritization scheme 500.

Secondary Gen-AI prompt 709 (“Adjust the brightness to 20% as user is in low light condition. Context good for video/audio. Play the audio through Bluetooth-connected headset.”) is created based on timing category “B” information 706—specifically, type category “2.0 Environmental Cues” and type category “3.0 Device Context.”

Tertiary Gen-AI prompt 710 “Summarization should be in 9:16 ratio and portrait mode video with text on the side. Other summarization options provided in audio book, text, etc.”) is created based on timing category “C” information 705.

Quaternary Gen-AI prompt 711 (“Adjust screen cold mode to better fit the low light condition.”) is also created based on timing category “B” information 706—specifically, type category “5.0 Content Context.”

The four Gen-AI prompts 708, 709, 710, and 711 may be used by Gen-AI 311 in FIG. 3 to generate the Gen-AI content summarization 313 for the example video content 701.

To summarize, within the example workflow 700 for the system 300 to extract prompts for Gen-AI: A user watches a documentary movie for 30% of the entire movie. The user then pauses and leaves the movie unfinished. After 2 months, the user returns at the point where the movie left off. Throughout the status changes from during content consumption, time away, and the resumption point, key information is being collected from the content or device metadata. In this example workflow 700, the collected key information is the content key points and settings during movie's consumption within the 30%, device usage during the time away of two months, and device context and settings at the resumption point when user is about to continue the content.

The key information being extracted or collected and organized per priority rules comprises:
[Priority A] 0.0 Content key points=“Documentary movie about scientists discovered a new comet. Entire movie is a mixture of space dark blue tone.”. 1.0 Interaction patterns=“User replayed 10′00” ~ 15′00″, and screenshotted at 15′00″”6.0 Content=“The documentary is a video in 1080p resolution. User played video on TV.”
[Priority B] 2.0 Environmental cues=“User is in a low light condition”. 3.0 Device context=“User returns to the content on phone at resumption point. Battery and network status is good (100%, Wi-Fi connected). Headphone connected”. 5.0 Device display preference=‘User's brightness setting is at 100%. User is using cold screen mode.’
[Priority C] 4.0 Other media=“User prefers to watch videos in portrait mode the most, in 9:16 ratio. User prefers to read articles and high text consumption behaviors. User has very low consumption behaviors on audio only media and images.”

Prioritization starts with Priority A key information, then adds Priority B key information, and finally adds Priority C key information. Prioritization starts with 0.0-0.1, then adds 1.0-1.1, . . . , and finally adds 6.0-6.1. The structure is organized layer by layer:
[Core prompt] (0.0, 1.0): “Generate a summarization for the documentary movie about scientists discovered a new comet using a dark blue color tone. Summarize the replay from 10′00″~15′00″ and screenshot point at 15′00″.”
[Add prompt] (2.0, 3.0): “Adjust the brightness to 20% as user is in low light condition. Context good for video/audio. Play the Audio through headset.”
[Additional prompt] (4.0): “Summarization should be in 9:16 ratio and portrait mode video with text on the side. Other summarization options provided in audio book, text etc.”
[Lower priority and conflicts] (5.0, 6.0): Current brightness 100%. Adjust screen cold mode to better fit the low light condition. Video on TV.”

FIG. 8 illustrates a framework 800 for user interactions upon resumption of paused content consumption, during provision of personalized summarization content based on content consumption and user status in the specific example used for the workflow 700. Upon user return 801 to paused content consumption, Gen-AI 311 analyzes (block 082) the prompt/instructions at the return point (when the app is opened by the user) and triggers display of user interface (UI) 803 seeking confirmation by the user consenting to summarization presentation. The user is provided the most suitable summarization content 804 (e.g., the primary summarization) as a default. However, the user can select other formats (e.g., the secondary summarization) by a user control (e.g., the “More” control in FIG. 8). Other options are displayed 805, and upon user selection the alternative format 806 is presented.

The user interaction framework 800 also allows for manually updating/editing 807 the prompt/instructions used by the Gen-AI 311. That is, the prompts may be re-edited for user's preferred selections to be used as Gen-AI prompts.

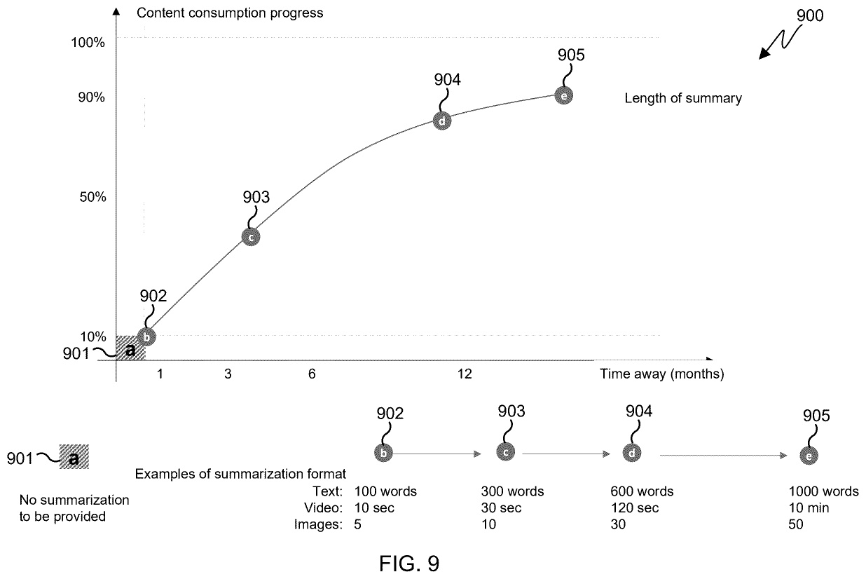

FIG. 9 illustrates a plot 900 for content summarization size based on initial content consumption and pause duration when providing personalized summarization content based on content consumption and user status in accordance with this disclosure. For ease of explanation, the plot 900 of FIG. 9 relates to the system 300 of FIG. 3 and the process 400 of FIG. 4. However, other system(s) and/or process(es) may function in a manner similar to the plot 900.

The plot 900 relates to the proportion of the content consumed as compared to the entire content versus the user's time away (in months) from consumption of the content. A minimum combination 901 of percent consumed and pause duration forms a condition (e.g., that described in connection with operation 410) for determining whether to provide a summarization to the user. Based on the initial progress and the time away from the content, the system 300 will use a threshold (10% and 1 month, for the example depicted) to decide when providing a summarization is necessary, and what is the length of summarization content should be presented. The threshold defines the necessity of summarization. For the example of FIG. 9, within the first month, if the user's initial consumption progress was under 10% of entire content, the system 300 will not provide summarization of the previously consumed content at user's return.

The values for content consumption progress as well as the time away (in months, for the example plot 900) will be used to define the length of the summarization, as well as the necessity. Once the threshold condition is satisfied, the combination of proportion already consumed and pause duration are employed to select a quantity of summarization to provide. Four exemplary points 902, 903, 904, and 905 and the corresponding amount of summarization in number of text words, video length, and number of images are illustrated in FIG. 9. While the content consumption progress increases (10%, 20%, . . . , 90%) and the user's time away from the content becomes longer (1 month, 3 months, . . . , 12 months), the system 300 will determine it more necessary to provide a summarization- and a longer summarization-upon the user's return. For instance, if user is watching a 4-hour movie at home, and pauses at 20% progress and, after 2 months of travelling, returns, the system 300 will employ Gen-AI 311 to generate a summarization having length between point 902 and point 903.

Although FIG. 9 illustrates one example of content summarization size when providing personalized summarization content based on content consumption and user status, various changes may be made to FIG. 9. For example, different correlation between content consumption progress, pause duration, and quantity of summarization content may be employed. In addition, the user's consumption of other content during the pause may be a consideration.

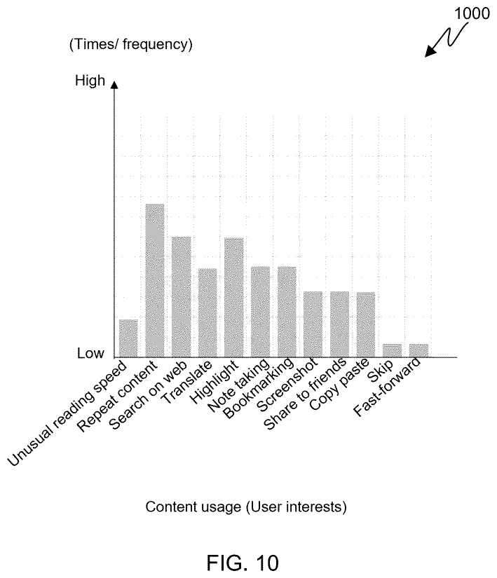

FIG. 10 illustrates a bar graph 1000 for user content consumption behavior as a basis for content summarization detail when providing personalized summarization content based on content consumption and user status in accordance with this disclosure. For ease of explanation, the bar graph 1000 of FIG. 10 relates to the system 300 of FIG. 3 and the process 400 of FIG. 4. However, other system(s) and/or process(es) may function in a manner similar to the bar graph 1000.

User content consumption behavior may be employed in defining a level of detail for a summarization. Based on the user's consumption behavior throughout a consuming process, the system 300 will record the user's various of interactions with the content. Each time when the user returns to the content at a certain progress point, the user interactions logged during previous consumption will influence the level of detail to be included in the summarization. FIG. 10 illustrates exemplary types of user interactions, including: reading speed; content repetition; related web searches; translations; highlighting; notes; bookmarking; screenshots; sharing with friends; copy and pastes; skipping; and fast-forwarding. As apparent, different ones of the exemplary user behaviors are applicable to different forms of content (e.g., e-books versus video).

When the user is consuming the content, the system 300 will record the consumption behaviors, which can be interactions or content usage pattern (times of repeating certain content such as a page in a book, or a section in a video; searches on web such as relevant keywords within the content; translation such as lookup for a word or phrase, etc.). Techniques for measuring user behaviors may be dependent on content type: reading speed for an e-book may be based on frequency of page flips, or repetition of specific video sessions or segments may be based on moving the progress bar (and include the number of times repeated). The same type(s) of user interaction occurring multiple times throughout the content consumption is also recorded and analyzed.

Although FIG. 10 illustrates one example of user content consumption behavior to be measured for determining content summarization detail when providing personalized summarization content based on content consumption and user status, various changes may be made to FIG. 8. For example, a user's concurrent interaction with other apps while consuming content (e.g., responding to received messages with a video playing in a picture-in-picture window) may be monitored.

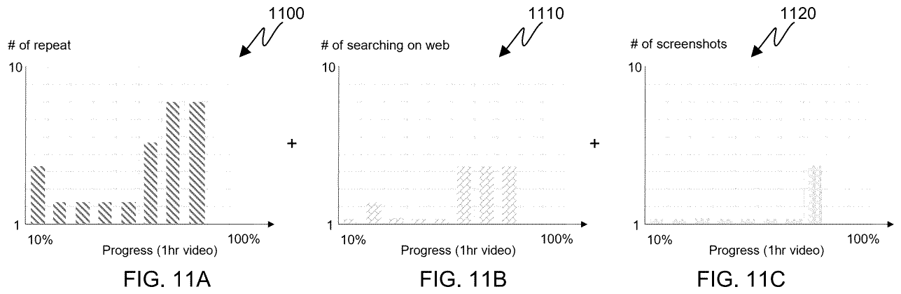

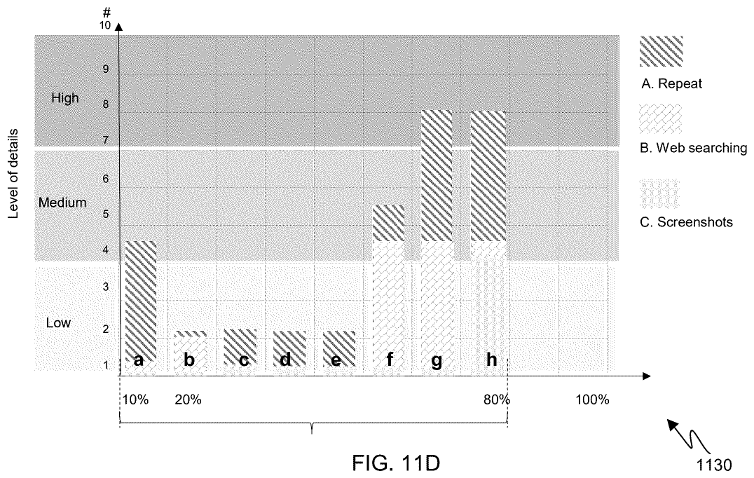

FIGS. 11A through 11C illustrate plots 1100, 1110, and 1120 for measured user content consumption behavior, and FIG. 11D illustrates a plot 1130 of aggregated behaviors, as a basis for content summarization detail when providing personalized summarization content based on content consumption and user status in accordance with this disclosure. For ease of explanation, the plots of FIGS. 11A through 11D relates to the system 300 of FIG. 3 and the process 400 of FIG. 4. However, other system(s) and/or process(es) may function in a manner similar to the plots depicted.

FIGS. 11A through 11C depict an example indicating the progress and the frequency of interactions of user's consumption behavior. The frequency of three types of user interaction (#of repeated segments, online searches, screenshots) is recorded throughout the content consumption. When the user returns (at % progress), the system 300 will analyze all user interaction status in previously consumed content. All user interactions are accumulated and calculated each time when the user pauses consumption. The detail level of summarization will vary in different parts of the entire video.

During consumption of 10% to about 80% of a 1 hour video: FIG. 11A illustrates plot 1100 for a number of times that a user repeated a content segment (e.g., to understand dialog or plot points); FIG. 11B illustrates plot 1110 for a number of times that a user conducted a web-based keyword search (e.g., to determine details of the video production, location or people or to lookup words or obtain translations); and FIG. 11C illustrates plot 1120 for a number of times that a user screenshotted the display (e.g., to capture information displayed and or to share with friends); FIG. 11D aggregates the measures of FIGS. 11A through 11C, and illustrates exemplary levels of summarization detail both for individual types of user interactions and user interaction in the aggregate. For example, the level of summarization detail for segment “h” in FIG. 11D could be high, since the overall user interaction with the content was the highest. The level of summarization detail for segments “f” and “g” in FIG. 11D could be high based on the instances of web searching occurring. By contrast, the level of summarization detail for segments “b” through “e” may be the lowest, based on low levels of user interaction. Further, the aggregate of types of user interaction over the consumed portion of the content may determine a level of summarization detail, with more detail provided for interactions “A” (content repetition) and “C” (screenshots) than for interaction “B” (web searches). Accordingly, in an example of a user that consumes 80% of the video before pausing and returns after 6 months, in general the summarization will focus more on segments “a,” “f,” “g,” and “h” when generated. More in-depth summarization will be provided with: high level of detail for segments “g” and “h,” where the most aggregate user interaction occurred and/or user interactions of type “A” occurred; medium level of detail for segments “f,” “g,” and “h,” where user interactions of type “B” occurred somewhat frequently; and low level of detail for the remaining segments. In sum, for example, the data represented in the segment “h” means that, from 70 min~80 min in the video, the user repeated 8 times at different or the same time slots, so summarization should include high detail of where those 8 times of repeating occurred; Web searching and screenshots both occurred 4-5 times during 70-80 min of the video, so summarization should include medium details of where web searching and screenshots happened.

Although FIGS. 11A through 11D illustrates one example of user content consumption behavior measurements for determining content summarization detail when providing personalized summarization content based on content consumption and user status, various changes may be made to FIGS. 11A through 11D. For example, more than three types of user interaction may be measured, and each type of user interaction may be weighted differently during aggregation.

It should be noted that content consumption activities are not limited to reading (e.g., users who read e-books), listening (e.g., users who listen to podcasts), and watching (e.g., users who watch long videos, movies, or episodic entertainment series), but may also include interactive content such as games. In addition, content consumption may occur through apps on mobile devices and in other manners. The summarization techniques described herein are well-suited for content consumers who commonly pursue long time content consumption behaviors, such as researchers, learners, movie lovers, etc.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

1. A method of providing a personalized content summarization based on a content consumption status and a user status, the method comprising:
during consumption of content by a user, identifying, for an aggregate portion of the content consumed by the user, user content consumption attributes including stage changes in consumption of the aggregated portion of the content consumed by the user, suitability of device status for a form of the personalized content summarization, content key points relating to characters, plot, and genre for the aggregate portion of the content consumed by the user, user interactions with the content during consumption, user preferences for the form of the personalized content summarization, and user content consumption behavior during the consumption of the aggregate portion of the content consumed by the user;
when the user pauses the consumption of the content for a time period exceeding a threshold:
applying prioritization to the user content consumption attributes according to priority levels for timing categories of the user content consumption attributes, wherein timing category priority levels for the content key points and the user interactions are each higher than a timing category priority level for the device status;
applying prioritization to the user content consumption attributes according to priority levels for type categories of the user content consumption attributes, wherein type category priority levels for the content key points and the user interactions are each higher than a type category priority level for the device status; and
based on the prioritization applied to the user content consumption attributes according to the priority levels for the timing categories and the prioritization applied to the user content consumption attributes according to the priority levels for the type categories, determining at least one generative artificial intelligence prompt for prediction, by a generative artificial intelligence model, of the personalized content summarization of the aggregate portion of the content consumed by the user; and
upon user return to the consumption of the content, determining whether to present the personalized content summarization to the user.

2. The method of claim 1, wherein determining the at least one generative artificial intelligence prompt for prediction of the personalized content summarization of the aggregate portion of the content consumed by the user comprises:
determining a type, a style, and a length of the personalized content summarization or device settings for presentation of the personalized content summarization.

3. The method of claim 2, wherein determining the type, the style, and the length of the personalized content summarization comprises:
determining a format of the personalized content summarization based on the user content consumption behavior.

4. The method of claim 1, wherein the user content consumption attributes include one or more of:
the user preferences, or
user status relating to the user content consumption behavior.

5. The method of claim 1, wherein determining the at least one generative artificial intelligence prompt for prediction of the personalized content summarization of the aggregate portion of the content consumed by the user comprises:
determining the at least one generative artificial intelligence prompt based at least in part on one or more of:
a proportion of the aggregate portion of the content consumed by the user to a total amount of the content,
a duration of the time period during which the user pauses the consumption of the content, or
a resumption point when the user returns to the content.

6. The method of claim 5, wherein determining whether to present the personalized content summarization to the user is based at least in part on one of:
the proportion of the portion of the content consumed by the user to the total amount of the content, or
the duration of the time period during which the user pauses the consumption of the content.

7. The method of claim 1, wherein determining whether to present the personalized content summarization to the user comprises:
requesting user confirmation for presentation of the summarization.

8. An electronic device for providing a personalized content summarization based on a content consumption status and a user status, the electronic device comprising:
at least one processing device configured to:
during consumption of content by a user, identify, for an aggregate portion of the content consumed by the user, user content consumption attributes including stage changes in consumption of the aggregated portion of the content consumed by the user, suitability of device status for a form of the personalized content summarization, content key points relating to characters, plot, and genre for the aggregate portion of the content consumed by the user, user interactions with the content during consumption, user preferences for the form of the personalized content summarization, and user content consumption behavior during the consumption of the aggregate portion of the content consumed by the user;
when the user pauses the consumption of the content for a time period exceeding a threshold:
apply prioritization to the user content consumption attributes according to priority levels for timing categories of the user content consumption attributes, wherein timing category priority levels for the content key points and the user interactions are each higher than a timing category priority level for the device status;
apply prioritization to the user content consumption attributes according to priority levels for type categories of the user content consumption attributes, wherein type category priority levels for the content key points and the user interactions are each higher than a type category priority level for the device status; and
based on the prioritization applied to the user content consumption attributes according to the priority levels for the timing categories and the prioritization applied to the user content consumption attributes according to the priority levels for the type categories, determine at least one generative artificial intelligence prompt for prediction, by a generative artificial intelligence model, of the personalized content summarization of the aggregate portion of the content consumed by the user; and
upon user return to the consumption of the content, determine whether to present the personalized content summarization to the user.

9. The electronic device of claim 8, wherein, to determine the at least one generative artificial intelligence prompt for prediction of the personalized content summarization of the aggregate portion of the content consumed by the user, the at least one processing device is configured to determine a type, a style, and a length of the personalized content summarization or device settings for presentation of the personalized content summarization.

10. The electronic device of claim 9, wherein, to determine the type, the style, and the length of the personalized content summarization, the at least one processing device is configured to determine a format of the personalized content summarization based on the user content consumption behavior.

11. The electronic device of claim 8, wherein the user content consumption attributes include one or more of:
the user preferences, or
user status relating to the user content consumption behavior.

12. The electronic device of claim 8, wherein, to determine the at least one generative artificial intelligence prompt for prediction of the personalized content summarization of the aggregate portion of the content consumed by the user, the at least one processing device is configured to determine the at least one generative artificial intelligence prompt based at least in part on one or more of:
a proportion of the aggregate portion of the content consumed by the user to a total amount of the content,
a duration of the time period during which the user pauses the consumption of the content, or
a resumption point when the user returns to the content.

13. The electronic device of claim 12, wherein the at least one processing device is configured to determine whether to present the personalized content summarization to the user based at least in part on one of:
the proportion of the aggregate portion of the content consumed by the user to the total amount of the content, or
the duration of the time period during which the user pauses the consumption of the content.

14. The electronic device of claim 8, wherein, to determine whether to present the personalized content summarization to the user, the at least one processing device is configured to request user confirmation for presentation of the summarization.

15. A non-transitory machine readable medium for providing a personalized content summarization based on a content consumption status and a user status, the non-transitory machine readable medium comprising instructions that when executed cause at least one processing device of an electronic device to:
during consumption of content by a user, identify, for an aggregate portion of the content consumed by the user, user content consumption attributes including stage changes in consumption of the aggregated portion of the content consumed by the user, suitability of device status for a form of the personalized content summarization, content key points relating to characters, plot, and genre for the aggregate portion of the content consumed by the user, user interactions with the content during consumption, user preferences for the form of the personalized content summarization, and user content consumption behavior during the consumption of the aggregate portion of the content consumed by the user;
when the user pauses the consumption of the content for a time period exceeding a threshold:
apply prioritization to the user content consumption attributes according to priority levels for timing categories of the user content consumption attributes, wherein timing category priority levels for the content key points and the user interactions are each higher than a timing category priority level for the device status;
apply prioritization to the user content consumption attributes according to priority levels for type categories of the user content consumption attributes, wherein type category priority levels for the content key points and the user interactions are each higher than a type category priority level for the device status; and
based on the prioritization applied to the user content consumption attributes according to the priority levels for the timing categories and the prioritization applied to the user content consumption attributes according to the priority levels for the type categories, determine at least one generative artificial intelligence prompt for prediction, by a generative artificial intelligence model, of the personalized content summarization of the aggregate portion of the content consumed by the user; and
upon user return to the consumption of the content, determine whether to present the personalized content summarization to the user.

16. The non-transitory machine readable medium of claim 15, wherein the instructions that when executed cause the at least one processing device to determine the at least one generative artificial intelligence prompt for prediction of the personalized content summarization of the aggregate portion of the content consumed by the user comprise:
instructions that when executed cause the at least one processing device to determine a type, a style, and a length of the personalized content summarization or device settings for presentation of the personalized content summarization.

17. The non-transitory machine readable medium of claim 16, wherein the instructions that when executed cause the at least one processing device to determine the type, the style, and the length of the personalized content summarization comprise:
instructions that when executed cause the at least one processing device to determine a format of the personalized content summarization based on user content consumption behavior.

18. The non-transitory machine readable medium of claim 15, wherein the user content consumption attributes include one or more of:
the user preferences, or
user status relating to the user content consumption behavior.

19. The non-transitory machine readable medium of claim 15, wherein the instructions that when executed cause the at least one processing device to determine the at least one generative artificial intelligence prompt for prediction of the personalized content summarization of the aggregate portion of the content consumed by the user comprise:
instructions that when executed cause the at least one processing device to determine the at least one generative artificial intelligence prompt based at least in part on one or more of:
a proportion of the aggregate portion of the content consumed by the user to a total amount of the content,
a duration of the time period during which the user pauses the consumption of the content, or
a resumption point when the user returns to the content.

20. The non-transitory machine readable medium of claim 19, wherein the instructions that when executed cause the at least one processing device to determine whether to present the personalized content summarization to the user comprise:
instructions that when executed cause the at least one processing device to determine whether to present the personalized content summarization to the user based at least in part on one of:
the proportion of the aggregate portion of the content consumed by the user to the total amount of the content, or
the duration of the time period during which the user pauses the consumption of the content.
